(19) United States
(12) Patent Application Publication
(10) Pub. No.: US 2019/0385485 A1
(43) Pub. Date: Dec. 19, 2019

(54) INTRAVENOUS INJECTION PRACTICE ASSEMBLY

(71) Applicants: Nancy Walker, Winston-Salem, NC (US); Kimberly Rao, Winston-Salem, NC (US)

(72) Inventors: Nancy Walker, Winston-Salem, NC (US); Kimberly Rao, Winston-Salem, NC (US)

(21) Appl. No.: 16/009,385

(22) Filed: Jun. 15, 2018

(51) Int. Cl. G09B 23/28; G09B 23/30; G09B 9/00

(52) U.S. Cl. CPC G09B 23/285; G09B 9/00; G09B 23/30

(57) ABSTRACT

An intravenous injection practice assembly for practicing intravenous injections includes a prosthesis that is structured to resemble a human arm. The prosthesis is comprised of a compressible material such that the prosthesis is analogous to the human arm. Thus, the prosthesis can be pierced by an intravenous needle during practicing intravenous injection. A control circuit is positioned within the prosthesis and a sensing array is positioned within the prosthesis. The sensing array is electrically coupled to the control circuit and the control circuit receives a first input when the sensing array senses that the intravenous needle has touched the sensing array. An alert is coupled to the prosthesis and the alert is electrically coupled to the control circuit. The alert is turned on when the control circuit receives the first input to communicate to user that the user has inserted the intravenous needle a proper depth into the prosthesis.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to practice devices and more particularly pertains to a new practice device for practicing intravenous injection.

### BRIEF SUMMARY OF THE INVENTION

An embodiment of the disclosure meets the needs presented above by generally comprising a prosthesis that is structured to resemble a human arm. The prosthesis is comprised of a compressible material such that the prosthesis is analogous to the human arm. Thus, the prosthesis can be pierced by an intravenous needle during practicing intravenous injection. A control circuit is positioned within the prosthesis and a sensing array is positioned within the prosthesis. The sensing array is electrically coupled to the control circuit and the control circuit receives a first input when the sensing array senses that the intravenous needle has touched the sensing array. An alert is coupled to the prosthesis and the alert is electrically coupled to the control circuit. The alert is turned on when the control circuit receives the first input to communicate to user that the user has inserted the intravenous needle a proper depth into the prosthesis.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top phantom view of an intravenous injection practice assembly according to an embodiment of the disclosure.

FIG. 2 is a bottom view of an embodiment of the disclosure.

FIG. 3 is a back phantom view of an embodiment of the disclosure.

FIG. 4 is a perspective in-use view of an embodiment of the disclosure.

FIG. 5 is a cross sectional view taken along line 5-5 of FIG. 1 of an embodiment of the disclosure.

### DETAILED DESCRIPTION OF THE INVENTION

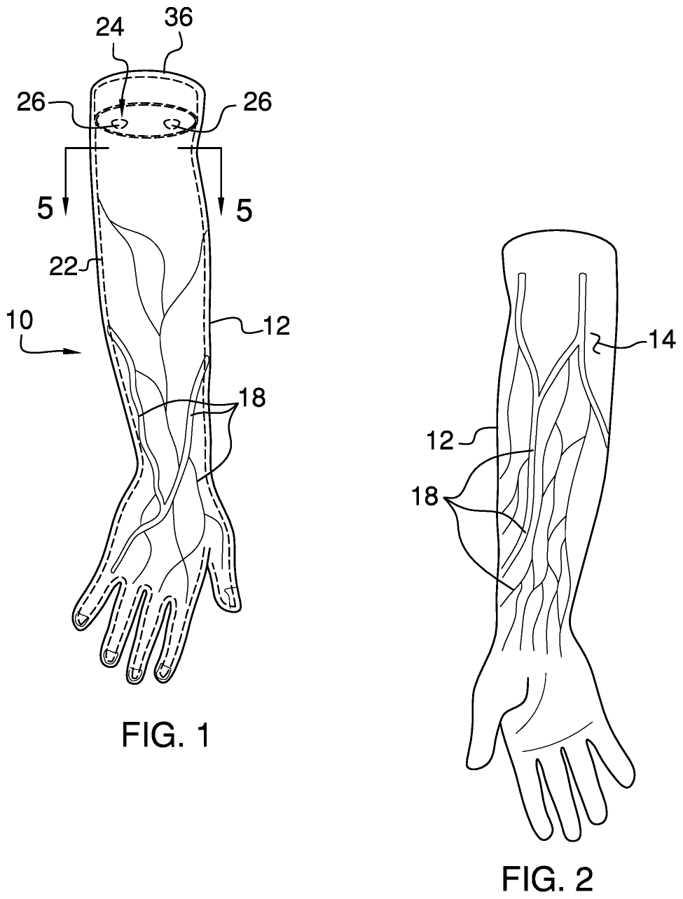

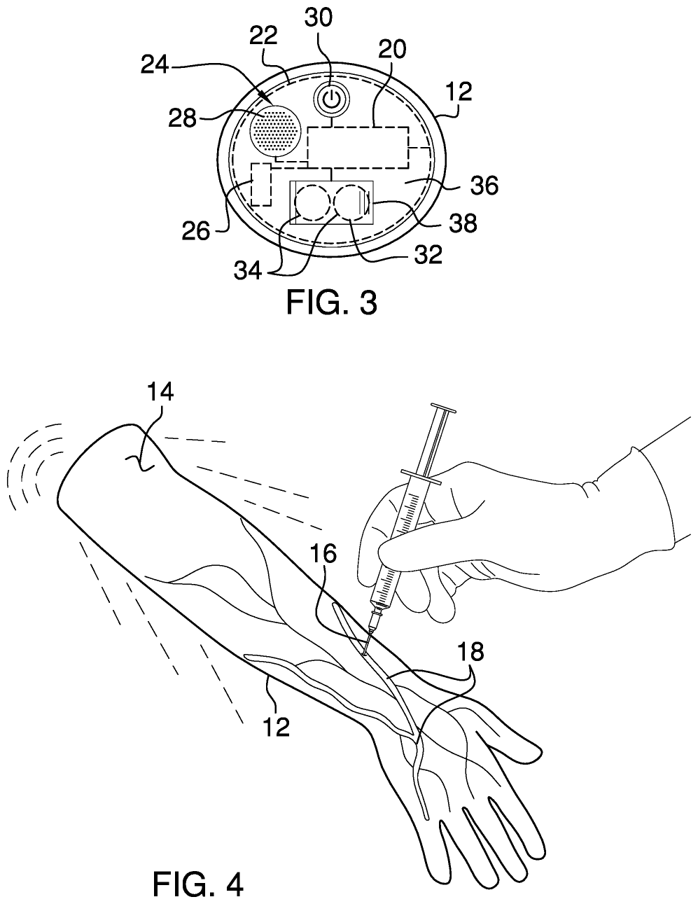

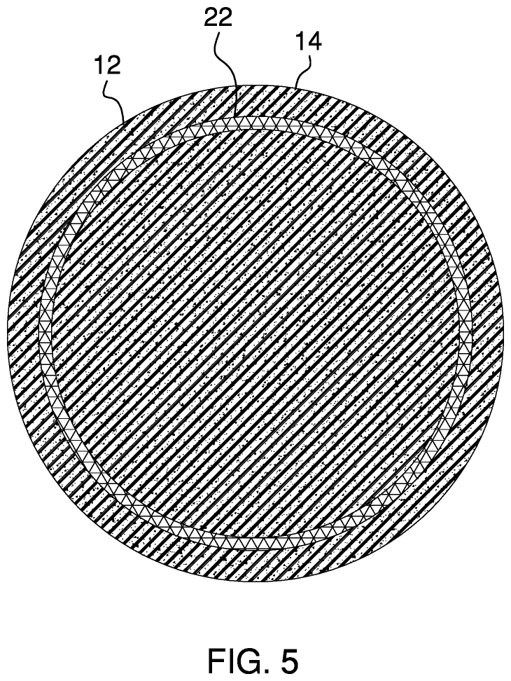

With reference now to the drawings, and in particular to FIGS. 1 through 5 thereof, a new practice device embodying the principles and concepts of an embodiment of the disclosure and generally designated by the reference numeral 10 will be described.

As best illustrated in FIGS. 1 through 6, the intravenous injection practice assembly 10 generally comprises a prosthesis 12 that is structured to resemble a human forearm 13 and hand 15. The prosthesis 12 is comprised of a compressible material such that the prosthesis 12 is analogous to the human arm. Moreover, the compressible material may be silicon or other similar material that simulates the texture and density of the human arm. The prosthesis 12 has an outer surface 14 and the outer surface 14 of the prosthesis 12 is pierced by an intravenous needle 16 during practicing intravenous injection. A plurality of tubes 18 is provided and the plurality of tubes 18 is positioned within the prosthesis 12 to simulate positioning of veins in the human arm 12. Each of the tubes 18 is comprised of a pierceable material such that each of the tubes 18 may be pierced by the intravenous needle 16.

A control circuit 20 is positioned within the prosthesis 12 and a sensing array 22 is positioned within the prosthesis 12. The sensing array 22 is electrically coupled to the control circuit 20. The sensing array 22 is spaced from the outer surface 14 of the prosthesis 12 a distance that corresponds to a depth of veins within a human arm 12. The sensing array 22 is comprised of an electrically conductive material. Thus, the sensing array 22 is in electrical communication with the intravenous needle 16 when the intravenous needle 16 pierces the sensing array 22.

The control circuit 20 receives a first input when the sensing array 22 senses that the intravenous needle 16 has pierced the sensing array 22. The sensing array 22 may be a capacitance sensing array or the like that can detect any electrically conductive object that comes into electrical communication with the sensing array 22. Alternatively, the sensing array 22 may surround each of the tubes 18 within the prosthesis 12 or the sensing array 22 may be positioned within each of the tubes 18 within the prosthesis 12. In this way the sensing array 22 may detect when one of the tubes 18 is pierced by the intravenous needle 16 and the control circuit 20 may receive the first input when one of the tubes 18 is pierced by the intravenous needle 16.

An alert 24 is coupled to the prosthesis 12 and the alert 24 is electrically coupled to the control circuit 20. The alert 24 is turned on when the control circuit 20 receives the first input. Thus, the alert 24 communicates to a user, such as a medical trainee who is practicing intravenous needle 16 insertion, that the user has inserted the intravenous needle 16 a proper depth into the prosthesis 12. In this way the user can practice intravenous injection without causing pain and discomfort to a real human being.

The alert 24 comprises a plurality of light emitters 26 and each of the light emitters 26 is positioned within the prosthesis 12. The prosthesis 12 may be comprised of a translucent material thereby facilitating light from the light emitters 26 to pass through the prosthesis 12. The plurality of light emitters 26 emits light outwardly from the prosthesis 12 when the control circuit 20 receives the first input. In this way the plurality of light emitters 26 communicates a visual alert 24 to the user that the user has inserted the intravenous needle 16 the proper depth into the prosthesis 12 with respect to delivering an intravenous injection. Each of the light emitters 26 may comprise an LED or the like. Alternatively, the plurality of light emitters 26 may be positioned on the outer surface 14 of the prosthesis 12. A speaker 28 is coupled to the prosthesis 12 and the speaker 28 is electrically coupled to the control circuit 20. The speaker 28 emits an audible alert 24 when the control circuit 20 receives the first input thereby communicating the audible alert 24 to the user in conjunction with the visual alert 24.

A power button 30 is coupled to the prosthesis 12 and the power button 30 is electrically coupled the control circuit 20. The power button 30 turns the control circuit 20 on and off when the power button 30 is manipulated. A power supply 32 is coupled to the prosthesis 12 and the power supply 32 is electrically coupled to the control circuit 20. The power supply 32 comprises at least one battery 34. Each of the speaker 28 and the power button 30 may be positioned on a distal end 36 of the forearm 13 with respect to the hand 15. A battery cover 38 may be removably coupled to the distal end 36 of the forearm 13 and the power supply 32 may be positioned beneath the battery cover 38.

In use, the prosthesis 12 is used during training for medical professionals in the art of performing an intravenous injection. The power button 30 is manipulated to turn the control circuit 20 on and training with piercing the prosthesis 12 with the intravenous needle 16 commences. The control circuit 20 receives the first input when the sensing array 22 comes into physical contact with the intravenous needle 16. Each of the light emitters 26 is turned on and the speaker 28 is turned on when the control circuit 20 receives the first input. In this way the user is informed that the intravenous needle 16 has been properly inserted into the prosthesis 12 for administering the intravenous injection.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An intravenous injection practice assembly being configured to train puncturing veins with an intravenous needle, said assembly comprising:
an prosthesis being structured to resemble a human arm, said prosthesis being comprised of a compressible material such that said prosthesis is analogous to the human arm wherein said prosthesis is configured to be pierced by a intravenous needle during practicing intravenous injection;
a control circuit being positioned within said prosthesis;
a sensing array being positioned within said prosthesis, said sensing array being electrically coupled to said control circuit, said control circuit receiving a first input when said sensing array senses that the intravenous needle has touched said sensing array; and
an alert being coupled to said prosthesis, said alert being electrically coupled to said control circuit, said alert being turned on when said control circuit receives said first input wherein said alert is configured to communicate to user that the user has inserted the intravenous needle a proper depth into the prosthesis.

2. The assembly according to claim 1, further comprising a plurality of tubes, said plurality of tubes being positioned within said prosthesis to simulate positioning of veins in a human arm, each of said tubes being comprised of a pierceable material wherein each of said tubes is configured to be pierced by the intravenous needle.

3. The assembly according to claim 1, wherein said alert comprises a plurality of light emitters, said light emitters being positioned within said prosthesis, said plurality of light emitters emitting light outwardly from said prosthesis when said control circuit receives said first input wherein said plurality of light emitters is configured to communicate a visual alert to the user.

4. The assembly according to claim 3, further comprising a speaker being coupled to said prosthesis, said speaker emitting an audible alert when said control circuit receives said first input.

5. The assembly according to claim 1, further comprising a power button being coupled to said prosthesis, said power button being electrically coupled said control circuit, said power button turning said control circuit on and off.

6. The assembly according to claim 5, further comprising a power supply being coupled to said prosthesis, said power supply being electrically coupled to said control circuit, said power supply comprising at least one battery.

7. The assembly according to claim 2, wherein:
said prosthesis has an outer surface; and
said sensing array is spaced from said outer surface of said prosthesis a distance that corresponds to a depth of veins within a human arm.

8. An intravenous injection practice assembly being configured to train puncturing veins with an intravenous needle, said assembly comprising:
an prosthesis being structured to resemble a human arm, said prosthesis being comprised of a compressible material such that said prosthesis is analogous to the human arm wherein said prosthesis is configured to be pierced by a intravenous needle during practicing intravenous injection, said prosthesis having an outer surface;
a plurality of tubes, said plurality of tubes being positioned within said prosthesis to simulate positioning of veins in a human arm, each of said tubes being comprised of a pierceable material wherein each of said tubes is configured to be pierced by the intravenous needle;
a control circuit being positioned within said prosthesis;
a sensing array being positioned within said prosthesis, said sensing array being electrically coupled to said control circuit, said sensing array being spaced from said outer surface of said prosthesis a distance that corresponds to a depth of veins within a human arm, said control circuit receiving a first input when said sensing array senses that the intravenous needle has touched said sensing array, said sensing array being comprised of an electrically conductive material wherein said sensing array is configured to be in electrical communication with the intravenous needle when the intravenous needle pierces said sensing array;
an alert being coupled to said prosthesis, said alert being electrically coupled to said control circuit, said alert being turned on when said control circuit receives said first input wherein said alert is configured to communicate to user that the user has inserted the intravenous needle a proper depth into the prosthesis, said alert comprising:
a plurality of light emitters, said light emitters being positioned within said prosthesis, said plurality of light emitters emitting light outwardly from said prosthesis when said control circuit receives said first input wherein said plurality of light emitters is configured to communicate a visual alert to the user; and
a speaker being coupled to said prosthesis, said speaker emitting an audible alert when said control circuit receives said first input;
a power button being coupled to said prosthesis, said power button being electrically coupled said control circuit, said power button turning said control circuit on and off; and
a power supply being coupled to said prosthesis, said power supply being electrically coupled to said control circuit, said power supply comprising at least one battery.
